(19) United States
(12) Patent Application Publication
(10) Pub. No.: US 2007/0026288 A1
(43) Pub. Date: Feb. 1, 2007

(54) Electrochemical cell with flow field member

(76) Inventor: Jacob Friedman, Storrs, CT (US)

Correspondence Address: CANTOR COLBURN, LLP - PROTON, 55 GRIFFIN ROAD SOUTH, BLOOMFIELD, CT, 06002, US

(21) Appl. No.: 11/191,749

(22) Filed: Jul. 28, 2005

(51) Int. Cl. H01M 8/02; H01M 8/10

(52) U.S. Cl. 429/38; 429/66; 429/30

(57) ABSTRACT

An electrochemical cell having a membrane electrode assembly (MEA), a cell separator plate, and a plurality of compressible layers of a carbon material is disclosed. The cell separator plate is disposed on a side of the MEA and defines a flow field that extends from the MEA to the cell separator plate. The plurality of compressible layers includes a carbon material disposed within the flow field such that the loading of the cell is substantially defined by the compression of the plurality of compressible layers.

### BACKGROUND OF INVENTION

The present disclosure relates generally to electrochemical cells, and particularly to electrochemical cell flow fields.

Electrochemical cells are energy conversion devices that may be classified as electrolysis cells or fuel cells. A proton exchange membrane electrolysis cell can function as a hydrogen generator by electrolytically decomposing water to produce hydrogen and oxygen gas, and can function as a fuel cell by electrochemically reacting hydrogen with oxygen to generate electricity. Referring to FIG. 1, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exits cell 100, while protons 106 and water 110 migrate across a proton exchange membrane 118 to cathode 114 where hydrogen gas 112 is formed.

Another typical water electrolysis cell using the same configuration as is shown in FIG. 1 is a cathode feed cell, wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

A typical fuel cell uses the same general configuration as is shown in FIG. 1. Hydrogen gas is introduced to the hydrogen electrode (the anode in fuel cells), while oxygen, or an oxygen-containing gas such as air, is introduced to the oxygen electrode (the cathode in fuel cells). Water can also be introduced with the feed gas. The hydrogen gas for fuel cell operation can originate from a pure hydrogen source, hydrocarbon, methanol, or any other hydrogen source that supplies hydrogen at a purity suitable for fuel cell operation (i.e., a purity that does not poison the catatlyst or interfere with cell operation). Hydrogen gas electrochemically reacts at the anode to produce protons and electrons, wherein the electrons flow from the anode through an electrically connected external load, and the protons migrate through the membrane to the cathode. At the cathode, the protons and electrons react with oxygen to form water, which additionally includes any feed water that is dragged through the membrane to the cathode. The electrical potential across the anode and the cathode can be exploited to power an external load.

In other embodiments, one or more electrochemical cells may be used within a system to both electrolyze water to produce hydrogen and oxygen, and to produce electricity by converting hydrogen and oxygen back into water as needed. Such systems are commonly referred to as regenerative fuel cell systems.

Electrochemical cell systems typically include a number of individual cells arranged in a stack, with the working fluids directed through the cells via input and output conduits formed within the stack structure. The cells within the stack are sequentially arranged, each including a cathode, a proton exchange membrane (PEM), and an anode. The cathode and anode may be separate layers or may be integrally arranged with the membrane. Each cathode/membrane/anode assembly (hereinafter “membrane electrode assembly”, or “MEA”) typically has a first flow field in fluid communication with the cathode and a second flow field in fluid communication with the anode. The MEA may furthermore be supported on both sides by screen packs or bipolar plates disposed within flow fields. Screen packs or bipolar plates may facilitate fluid movement to and from the MEA, membrane hydration, and may also provide mechanical support for the MEA.

In order to maintain intimate contact between cell components under a variety of operational conditions and over long time periods, uniform compression is applied to the cell components. Pressure pads or other compression means are often employed to provide even compressive force from within the electrochemical cell.

While existing internal components are suitable for their intended purposes, there still remains a need for improvement, particularly regarding cell efficiency at lower cost, weight and size. Accordingly, a need exists for improved internal cell components of an electrochemical cell that can operate at sustained high pressures and low resistivities, while offering a low profile configuration at a low cost.

### BRIEF DESCRIPTION OF THE INVENTION

An embodiment of the invention includes an electrochemical cell having a membrane electrode assembly (MEA), a cell separator plate, and a plurality of compressible layers of a carbon material. The cell separator plate is disposed on a side of the MEA and defines a flow field that extends from the MEA to the cell separator plate. The plurality of compressible layers includes a carbon material disposed within the flow field such that the loading of the cell is substantially defined by the compression of the plurality of compressible layers.

Another embodiment of the invention includes an electrochemical cell having a membrane electrode assembly (MEA), a cell separator plate, and a plurality of compressible layers of a carbon material. The cell separator plate is disposed on a side of the MEA and defines a flow field that extends from the MEA to the cell separator plate. The plurality of compressible layers includes carbon paper, cloth of random carbon fiber, woven cloth of carbon strands, woven cloth of multi-strand carbon, or any combination of the foregoing, disposed within the flow field such that the plurality of compressible layers occupy the flow field from the MEA to the cell separator plate. At least one of the plurality of compressible layers includes flow channels formed in the layer, thereby increasing lateral flow within the plurality of layers.

### BRIEF DESCRIPTION OF THE DRAWINGS

Referring now to the figures wherein like elements are numbered alike:

FIG. 1 depicts a schematic diagram of a partial electrochemical cell showing an electrochemical reaction for use in accordance with an embodiment of the invention;

FIG. 2 depicts an exploded assembly isometric view of an exemplary electrochemical cell in accordance with an embodiment of the invention;

FIGS. 3 and 4 depict expanded schematic diagrams of alternative electrochemical cells to that depicted in FIG. 2;

FIG. 5 depicts a set of curves illustrating an operational characteristic of an exemplary embodiment of the invention;

FIGS. 6 and 7 depict alternative configurations of a compressible layer in accordance with an embodiment of the invention; and

FIG. 8 depicts a section view through a portion of the layer of FIG. 6.

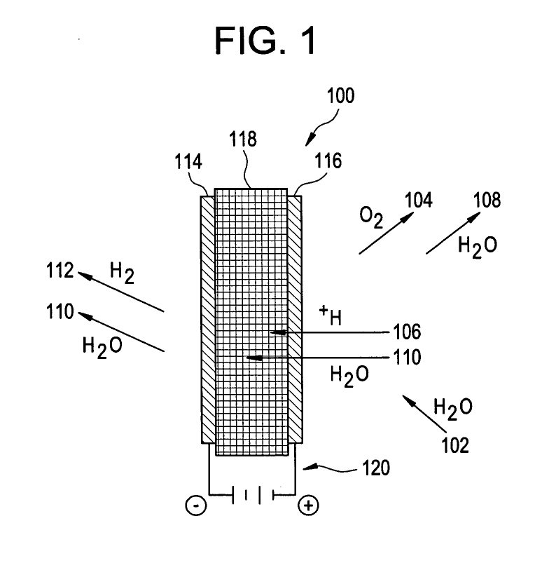

### DETAILED DESCRIPTION OF THE INVENTION

Disclosed herein are novel embodiments for an electrochemical cell having electrically conductive, elastically compressible and hydrogen compatible carbon components strategically disposed within the cell.

Although the disclosure herein is described in relation to a proton exchange membrane (PEM) electrochemical cell employing hydrogen, oxygen, and water, other types of electrochemical cells and/or electrolytes and/or reactants may be used in accordance with an embodiment of the invention and the teachings disclosed herein. Upon the application of different reactants and/or different electrolytes, the flows and reactions are understood to change accordingly, as is commonly understood in relation to that particular type of electrochemical cell.

Referring to FIG. 2, an electrochemical cell (cell) 200 suitable for operation as an anode feed electrolysis cell, cathode feed electrolysis cell, fuel cell, or regenerative fuel cell is depicted in an exploded assembly isometric view. Thus, while the discussion below is directed to an anode feed electrolysis cell, cathode feed electrolysis cells, fuel cells, and regenerative fuel cells are also contemplated. Cell 200 is typically one of a plurality of cells employed in a cell stack as part of an electrochemical cell system. When cell 200 is used as an electrolysis cell, power inputs are generally between about 1.48 volts and about 3.0 volts, with current densities between about 50 A/ft² (amperes per square foot) and about 4,000 A/ft². When used as a fuel cells power outputs range between about 0.4 volts and about 1 volt, and between about 0.1 A/ft² and about 10,000 A/ft². The number of cells within the stack, and the dimensions of the individual cells is scalable to the cell power output and/or gas output requirements. Accordingly, application of electrochemical cell 200 may involve a plurality of cells 200 arranged electrically either in series or parallel depending on the application. An alignment pin 300 may be used to maintain the alignment of the components of cell 200.

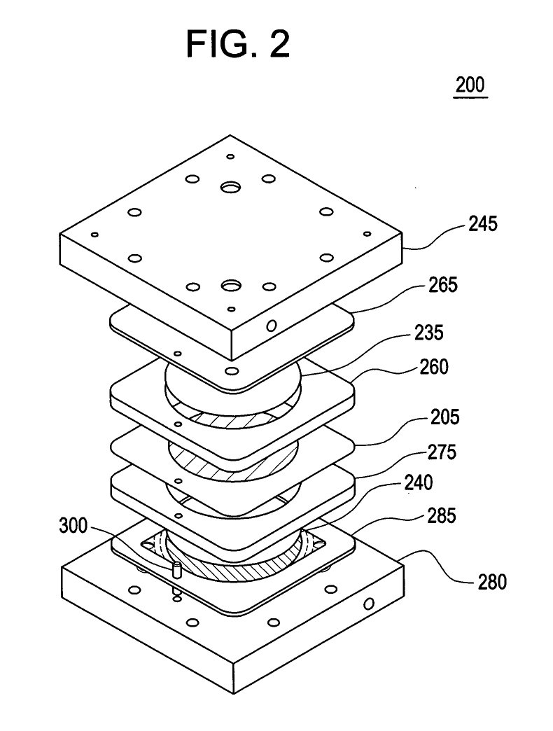

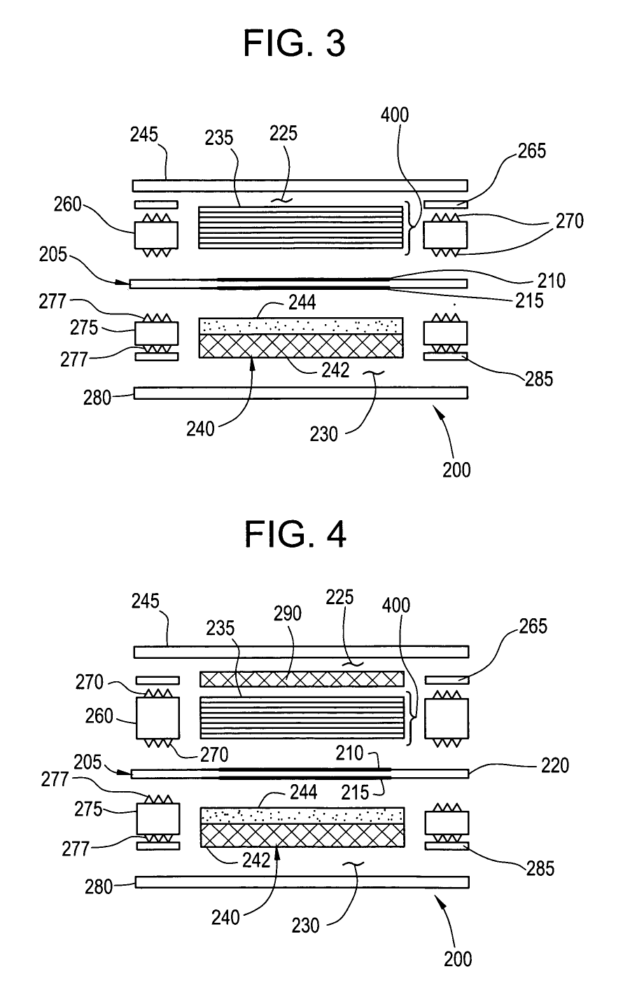

Cells may be operated at a variety of pressures, such as up to or exceeding about 100 psi, up to or exceeding about 500 psi, up to or exceeding about 2500 psi, or even up to or exceeding about 10,000 psi, for example. In an embodiment, cell 200 includes a membrane-electrode-assembly (MEA) 205 having a first electrode (e.g., cathode) 210 and a second electrode (e.g., anode) 215 disposed on opposite sides of a proton exchange membrane (membrane) 220, best seen by now referring to FIG. 3. Exemplary flow fields 225, 230, which are in fluid communication with electrodes 210 and 215, respectively, are defined generally by the regions proximate to, and bounded on at least one side by, each electrode 210 and 215 respectively. A flow field member 235 maybe disposed within flow field 225 between electrode 210 and a cell separator plate 245. A frame 260 generally surrounds flow field 225 and an optional gasket 265 may be disposed between frame 260 and cell separator plate 245 generally for enhancing the seal within the reaction chamber defined on one side of cell 200 by frame 260, cell separator plate 245 and electrode 210. Sealing features 270 may be employed on frame 260 for enhanced sealing.

Another flow field member 240 may be disposed in flow field 230. A frame 275 generally surrounds flow field member 240, a cell separator plate 280 is disposed adjacent flow field member 240 opposite oxygen electrode 215, and a gasket 285 is disposed between frame 275 and cell separator plate 280, generally for enhancing the seal within the reaction chamber defined by frame 275, cell separator plate 280, and the oxygen side of membrane 220. Sealing features 277 may be employed on frame 275 for enhanced sealing.

The cell components, particularly cell separator plates (also referred to as manifolds) 245, 280, frames 260, 275, and gaskets 265, 285 may be formed with suitable manifolds or other conduits for fluid flow.

In an embodiment, membrane 220 comprises electrolytes that are preferably solids or gels under the operating conditions of the electrochemical cell. Useful materials include proton conducting ionomers and ion exchange resins. Useful proton conducting ionomers include complexes comprising an alkali metal salt, alkali earth metal salt, a protonic acid, or a protonic acid salt. Useful complex-forming reagents include alkali metal salts, alkaline metal earth salts, and protonic acids and protonic acid salts. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt is complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins can include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is NAFION™ resins (commercially available from E. I. du Pont de Nemours and Company, Wilmington, Del.).

Electrodes 210 and 215 comprise a catalyst suitable for performing the needed electrochemical reaction (i.e., electrolyzing water and producing hydrogen). Suitable catalyst include, but are not limited to, materials comprising platinum, palladium, rhodium, carbon, gold, tantalum, tungsten, ruthenium, iridium, osmium, alloys of at least one of the foregoing catalysts, and the like. Electrodes 210 and 215 can be formed on membrane 220, or may be layered adjacent to, but in contact with, membrane 220.

In an embodiment, flow field member 240 includes a screen pack or a bipolar plate 242 in combination with a porous plate support member 244, with the porous plate 244 being adjacent MEA 205. A screen or bipolar plate 242 and porous plate 244, capable of supporting membrane 220, allowing the passage of system fluids, and preferably conducting electrical current, is desirable. In an embodiment, the screens may comprise layers of perforated sheets or a woven mesh formed from metal or strands. These screens are typically comprised of metals, such as, for example, niobium, zirconium, tantalum, titanium, carbon steel, stainless steel, nickel, cobalt, and alloys comprising at least one of the foregoing metals. The geometry of the openings in the screens can range from ovals, circles, and hexagons to diamonds and other elongated shapes. Bipolar plates are commonly porous structures comprising fibrous carbon or fibrous carbon impregnated with polytetrafluoroethylene or PTFE (commercially available under the trade name TEFLON® from E. I. du Pont de Nemours and Company). However, the bipolar plates are not limited to carbon or PTFE impregnated carbon, they may also be made of any of the foregoing materials used for the screens, such as niobium, zirconium, tantalum, titanium, carbon steel, stainless steel, nickel, cobalt, and associated alloys, for example.

With reference now to FIG. 3, cell separator plate 245 and MEA 205 define the flow field 225 that extends from MEA 205 to cell separator plate 245. In an embodiment, flow field member 235 on the hydrogen side of MEA 205 includes a plurality of compressible layers 400 made from a carbon material disposed within the flow field 225 such that the loading of the cell 200 is substantially defined by the compression of the plurality of compressible layers 400. As used herein, the term compressible refers to a material that is capable of being compressed with elastic and possibly some plastic deformation. In an embodiment, layers 400 are made from carbon paper, cloth of random carbon fiber, woven cloth of carbon strands, woven cloth of multi-strand carbon, or any combination having any of the foregoing materials. An exemplary material for layers 400 is TGP-H-120 carbon fiber paper available from Toray Industries. To serve as a flow field, each layer of the plurality of layers 400 should be porous. In exemplary embodiments, each of the layers 400 has an unloaded porosity equal to or greater than about 70%, or equal to or greater than about 75%, or equal to about 78%. To provide for compressibility in the assembled cell 200, it is desirable to use multiple layers 400 in excess of two, such as equal to or greater than six layers, or seven layers for example. However, embodiments of the invention are not limited to any specific quantify of layers 400. In exemplary embodiments, the unloaded thickness of each layer 400 is equal to or less than about 0.020 inches, or equal to or less than about 0.015 inches. In an embodiment having seven layers of TGP-H-120 carbon fiber material at a thickness of about 0.015 inches, a compression of about 0.007 to about 0.021 was observed at a loading of about 50-400 psi (pounds-per-square-inch). In an embodiment, such as that depicted in FIG. 3, the plurality of compressible layers 400 occupies the flow field 225 from the MEA 205 to the cell separator plate 245.

In an alternative embodiment, and with reference now to FIG. 4, one or more layers of an electrically conductive and porous stiffening material 290 may be disposed between the cell separator plate 245 and the plurality of compressible layers 400, thereby providing additional support for the compressible layers 400, and providing a more uniform load distribution over the active area of MEA 205. Additionally, the porosity of stiffening material 290 may improve the lateral and/or longitudinal flow within flow field 225. In exemplary embodiments, stiffening material layers 290 may be made from metal screens, etched metal plates, or similar materials as used for flow field member 240.

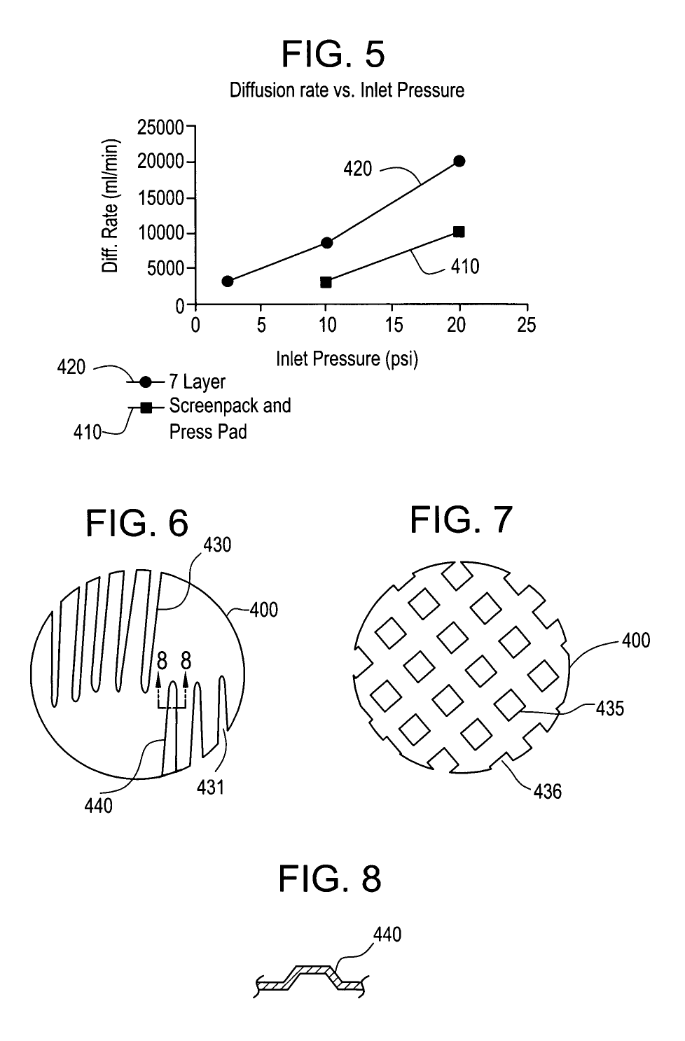

By employing a plurality of compressible layers 400 for flow field member 235, as herein disclosed, instead of a screen pack such as that used in flow field member 240, experimental data shows the unexpected advantage of being able to substantially improve the flow diffusion rate across the flow field 225 as a function of inlet pressure, which is depicted for an exemplary embodiment in FIG. 5.

With reference now to FIG. 5, two data curves of experimental data relating to an exemplary embodiment of the invention are presented. The first data curve 410 depicts the results of an experimental diffusion rate across a flow field having a screenpack as part of flow field member (element 240 of FIG. 3, but on the hydrogen side, for example) and a pressure pad (not shown but known in the art). The second data curve 420 depicts the results of an experimental diffusion rate across a similarly configured flow field but having an embodiment of the invention as a flow field member, such as a seven-layer arrangement of TGP-H-120 carbon fiber paper (element 400 of FIG. 3 for example).

As can be seen with reference to FIG. 5, the flow diffusion rate across an exemplary plurality of layers 400 is seen to be equal to or greater than about 5,000 milliliters-per-minute (ml/min) at an inlet pressure of about 10 pounds-per-square-inch (psi), and equal to or greater than about 12,000 ml/min at an inlet pressure of about 20 psi. More specifically, the flow diffusion rate across an exemplary plurality of layers 400 is seen to be equal to or greater than about 2,000 milliliters-per-minute (ml/min) at an inlet pressure of about 2.5 pounds-per-square-inch (psi), equal to or greater than about 7,000 ml/min at an inlet pressure of about 10 psi, and equal to or greater than about 19,000 ml/min at an inlet pressure of about 20 psi.

While FIG. 5 illustrates particular diffusion rates for two test cells having a particular, and the same, cell geometry (such as active area, inlet ports and cell frames for example), it will be appreciated that similar relative improvements may be observed for other cell geometries. By analyzing the diffusion rate across a particular flow field, it is contemplated that advantages associated with embodiments of the invention, and illustrated by FIG. 5, result from the use of a layered carbon flow field (plurality of layers 400), which have greater porosity than a metal screen pack and are more resistant to creep than is a rubber pressure pad, for example.

Another unexpected advantage observed from experimental testing of a plurality of compressible layers 400 as herein disclosed compared to a screen pack with pressure pad, found the plurality of compressible layers 400 to provide a more uniform distribution of loading across the active area of MEA 205, with substantially fewer hot spots of concentrated high loading.

In an alternative embodiment, and with reference now to FIGS. 6-8, each of the plurality of layers 400 may include flow channels 430, 435 formed in the layer, thereby increasing lateral flow within the plurality of layers 400 and within flow field 225. In an embodiment, at least one of the flow channels 430, 435 extends to an edge of the respective layer 400, as depicted at 431, 436. Exemplary flow channels 430, 435 may be through-cuts or embossed profiles. For illustration purposes, FIG. 6 depicts both through-cut flow channels 430, and an embossed flow channel 440. However, it will be appreciated that any layer 400 may have through-cuts, embossed flow channels, or a combination thereof. A cross section view of an exemplary embossed profile 440 is illustrated in FIG. 8. While embodiments of the invention are depicted having a certain geometry for flow channels 430, 435, it will be appreciated that this is for illustration purposes only, and that embodiments of the invention may employ any geometric profile suitable for the purposes disclosed herein.

In view of the foregoing, some embodiments of the invention may have some of the following advantages: a lower profile cell configuration having lower weight, size and cost; fewer plated parts resulting in fewer manufacturing process steps and process time as well as less use of chemicals often used in plating, which are typically harmful to the environment;; and, a hydrogen compatible flow field member that is electrically conductive, elastically compressible, and suitable for replacing typical metal-rubber composite pressure pads and plated metal screen packs.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An electrochemical cell comprising:
a membrane electrode assembly (MEA);
a cell separator plate disposed on a side of the MEA and defining a flow field that extends from the MEA to the cell separator plate; and
a plurality of compressible layers comprising carbon disposed within the flow field such that the loading of the cell is substantially defined by the compression of the plurality of compressible layers.

2. The electrochemical cell of claim 1, wherein:
the plurality of compressible layers occupy the flow field from the MEA to the cell separator plate.

3. The electrochemical cell of claim 1, wherein:
the MEA comprises a hydrogen electrode and an oxygen electrode, and the plurality of compressible layers are disposed proximate the hydrogen electrode.

4. The electrochemical cell of claim 1, wherein:
the plurality of compressible layers is in excess of two layers.

5. The electrochemical cell of claim 1, wherein:
the plurality of compressible layers comprises carbon paper, cloth of random carbon fiber, woven cloth of carbon strands, woven cloth of multi-strand carbon, or any combination comprising at least one of the foregoing.

6. The electrochemical cell of claim 1, wherein:
each of the plurality of compressible layers has an unloaded porosity equal to or greater than about 70%.

7. The electrochemical cell of claim 1, wherein:
each of the plurality of compressible layers has an unloaded thickness equal to or less than about 0.020 inches.

8. The electrochemical cell of claim 1, wherein:
each of the plurality of compressible layers has an unloaded thickness equal to or less than about 0.015 inches, and has an unloaded porosity equal to or greater than about 75%; and
the number of compressible layers is equal to or greater than six.

9. The electrochemical cell of claim 1, further comprising:
a second cell separator plate disposed on a side of the MEA opposite that of the first cell separator plate, and defining a second flow field that extends from the MEA to the second cell separator plate; and
a flow field member disposed within the second flow field.

10. The electrochemical cell of claim 9, wherein:
the flow field member comprises a screen pack and a porous plate, the porous plate being adjacent the MEA.

11. The electrochemical cell of claim 1, wherein:
at least one of the plurality of compressible layers comprises flow channels formed in the layer, thereby increasing lateral flow within the plurality of layers.

12. The electrochemical cell of claim 11, wherein:
at least one of the flow channels extends to an edge of the respective layer.

13. The electrochemical cell of claim 11, wherein:
the flow channels comprise through-cuts.

14. The electrochemical cell of claim 11, wherein:
the flow channels comprise embossed profiles.

15. The electrochemical cell of claim 1, further comprising:
one or more layers of electrically conductive and porous stiffening material disposed between the cell separator plate and the plurality of compressible layers.

16. The electrochemical cell of claim 15, wherein:
the stiffening material comprises metal screen.

17. An electrochemical cell comprising:
a membrane electrode assembly (MEA);
a cell separator plate disposed on a side of the MEA and defining a flow field that extends from the MEA to the cell separator plate; and
a plurality of compressible layers comprising carbon paper, cloth of random carbon fiber, woven cloth of carbon strands, woven cloth of multi-strand carbon, or any combination comprising at least one of the foregoing, disposed within the flow field such that the plurality of compressible layers occupy the flow field from the MEA to the cell separator plate;
wherein at least one of the plurality of compressible layers comprises flow channels formed in the layer, thereby increasing lateral flow within the plurality of layers.

18. The electrochemical cell of claim 17, further comprising:
a second cell separator plate disposed on a side of the MEA opposite that of the first cell separator plate, and defining a second flow field that extends from the MEA to the second cell separator plate; and
a flow field member disposed within the second flow field.

19. The electrochemical cell of claim 18, wherein:
the flow field member comprises a screen pack and a porous plate, the porous plate being adjacent the MEA.
